(19) United States
(12) Patent Application Publication
(10) Pub. No.: US 2013/0294474 A1
(43) Pub. Date: Nov. 7, 2013

(54) GASIFICATION MELTING FURNACE AND METHOD FOR TREATING COMBUSTIBLE MATERIAL USING THE SAME

(71) Applicant: GS PLATECH CO., LTD., Daejeon (KR)

(72) Inventors: Young-Suk KIM, Daejeon (KR); Soon-Mo HWANG, Seoul (KR); Chul-Jin DO, Daejeon (KR); Jin-Ho LEE, Daejeon (KR)

(73) Assignee: GS PLATECH CO., LTD., Daejeon (KR)

(21) Appl. No.: 13/887,552

(22) Filed: May 6, 2013

(30) Foreign Application Priority Data
May 4, 2012 (KR) 10-2012-0047755
May 4, 2012 (KR) 10-2012-0047757

(51) Int. Cl. H05H 1/26

(52) U.S. Cl. CPC H05H 1/26
USPC 373/19

(57) ABSTRACT

A gasification melting furnace includes a gasification part into which the combustible material inputs, a sedimentary part communicating with a lower part of the gasification part, and a melting part communicating with a lateral face of the sedimentary part and having a heater, wherein the sedimentary part is filled with the combustible material and a gas generated in the melting part passes through the combustible material and inputs into the gasification part, thereby stably and rapidly treating the combustible material, reducing energy consumption of the heater, and providing a synthetic gas containing decreased hazardous substances.

### CROSS REFERENCE TO RELATED APPLICATIONS AND CLAIM OF PRIORITY

This application claims priority to Korean Patent Application No. 10-2012-0047755, filed on May 4, 2012 and Korean Patent Application No. 10-2012-0047757, filed on May 4, 2012, in the Korean Intellectual Property Office, the entire disclosure of which is incorporated herein by reference.

### BACKGROUND

1. Field of the Invention

The present invention relates to a melting furnace for gasification and, more particularly, to a gasification melting furnace used for treating a waste-containing combustible material to generate energy therefrom.

2. Description of the Related Art

A reaction of converting combustible waste into energy may be assorted into incineration (burning) performed under an oxygen-rich atmosphere and gasification conducted under an oxygen-depleted atmosphere. Most of the waste generates hot exhaust gas through incineration and steam is recovered from waste heat of the exhaust gas. However, during incineration, a large amount of air contaminants (SOx, NOx, dioxin, etc.) and heavy metals in an amount of 10 to 20% of input are eluted, and incinerated ash requiring landfill is generated. Further, since the steam has low energy utility, waste treatment technologies based on gasification, which is considered as an alternative solution to incineration, have been also researched.

In general, gasification refers to a process of converting some components such as carbon, hydrogen, oxygen, etc., which are possibly altered into a gas phase at 600° C. or higher under a reductive atmosphere including less oxygen, into carbon monoxide, hydrogen, water and/or hydrocarbons. And, these components may be further pyrolyzed at a temperature of 1,000° C. or higher, thus being converted into carbon monoxide and hydrogen. The gasification is an endothermic reaction and may be performed by supplying a constant level of an external heat source. Herein, such a heat source may be heat generated while a part of synthetic gas is further oxidized and changed into carbon dioxide, and the heat causes the gasification to be performed. Accordingly, it is considered that, although the gasification is proceeding, carbon dioxide is partially included in the exhaust gas and the heat generated while generating carbon dioxide may be used in the endothermic reaction for gasification. Applying gasification may have advantages in that: it can inhibit formation of air contaminants (SOx, NOx, dioxin, etc.) generated during oxidation; enable power generation using a gas engine/turbine with higher efficiency than steam, or produce a synthetic gas capable of being converted into fuel such as hydrogen and ethanol; and/or convert non-combustible components included in combustible materials into vitreous slag other than ash through gasification at a high temperature.

However, most of currently developed gasification methods have significant difficulties in stably applying enthalpies required for gasification due to oxidation of a part of an input material, on the basis of uniformity of the input material and characteristics of waste having low calories. Additionally, since a thermal equilibrium temperature in the gasification is relatively low, it is considerably difficult to stably reach a high temperature of not less than 1,000° C. Also, an exhaust gas containing an unburned fraction or un-decomposed contaminants in large amounts will be probably discharged. Further, due to low temperature, what is obtainable may not be slag but ash.

In order to complete treatment of the waste, convert ash into slag, and stably provide a high temperature condition, a great deal of effort has gone into application of a plasma torch to treatment of waste and energy creation. Extensive research and development have been conducted into a plasma gasification melting furnace wherein, after melting/gasifying the waste using the energy provided by a plasma torch at a temperature of several thousand degrees Celsius, the unburned fraction is converted into slag while converting a burned fraction into a synthetic gas, which in turn creates energy. Specifically, in order to improve energy efficiency while considerably reducing an amount of input power (commonly, ‘electrical energy’) applied to plasma, significant efforts are continuing.

According to typical plasma gasification and melting, plasma is mostly used to elevate a temperature for a washing process in order to remove unburned carbon and hydrocarbons contained in a synthetic gas remaining after melting or gasification of non-combustible materials such as metal and ash. In addition, a conventional plasma gasification melting furnace is generally a vertical shaft furnace in a straight line shape, configured such that the waste is input into an upper part of the shaft furnace and moves to a lower part thereof in which a melting reaction is conducted, and a plurality of plasma torches are mounted on the bottom end. Each plasma torch may function to melt the waste moving toward a lower side of the melting part. Also, stable gasification may be performed by further feeding a high calorie fuel such as cokes. Molten metal is formed by a molten material on a bottom face of the melting part, and the synthetic gas rises to the upper part of the melting part and is discharged outside the melting part.

Since the conventional plasma gasification melting furnace has a straight line structure, the waste being input into the melting part must continuously move toward the bottom face of the melting part at a constant rate in order to perform stable melting and gasification. However, it is not easy to control a transfer speed of the waste. Further, in a case where the transfer speed of the waste toward the bottom face of the melting part is altered, some problems may occur in a treatment rate of the waste, melting and/or gasification. In particular, when an input amount of waste is increased, the waste may not efficiently come in contact with gas, to thus cause a problem of delaying a reaction or decreasing a reaction rate.

Further, in a conventional plasma gasification melting furnace, a melting reaction occurs at 1,600° C. but a gasification temperature is relatively low such as about 1,200° C. or less. Also, a temperature of discharging a synthetic gas is 1,000° C. or less. Therefore, the synthetic gas may contain several % of hydrocarbons and tar and dioxin may be possibly re-synthesized in a further process. Accordingly, a hot synthetic gas is immediately cooled to inhibit occurrence of contaminants during the further process, however, this process deteriorates energy efficiency. Since the further process for purification of a synthetic gas is normally executed in multi-stages, it may have complicated configurations and need excessive facilities. In order to overcome the above problems, the synthetic gas has sometimes been washed by elevating a temperature using plasma in recent years, however, this entails a drawback of deteriorating overall efficiency.

### SUMMARY

Accordingly, an aspect of the present invention is to provide a gasification melting furnace efficiently treating a great amount of waste and a method for treating a combustible material using the same.

Another aspect of the present invention is to provide a gasification melting furnace capable of providing a synthetic gas, which is free from hazardous substances such as tar or dioxin by gasification at a high temperature of 1,200° C. or higher, and a method for treating a combustible material using the same.

Another aspect of the present invention is to provide a gasification melting furnace capable of providing a synthetic gas, which is free from hazardous substances such as tar or dioxin, and a method for treating a combustible material using the same.

Another aspect of the present invention is to provide a gasification melting furnace capable of considerably decreasing electrical energy of a plasma torch by increasing power efficiency of the same.

In order to accomplish the above aspects, the present invention provides the followings.

A gasification melting furnace includes: a sedimentary part in which a combustible material having multiple pores formed therein is deposited; a melting part configured to melt the combustible material introduced from the sedimentary part; and a gasification part into which a gas generated in the melting part is input after passing through the pores in the sedimentary part.

The furnace may further include a combustible material inlet through which the combustible material is input into the sedimentary part.

The melting part may communicate with a lateral face of the sedimentary part and the gasification part communicates with a top side of the sedimentary part.

The melting part may include a plasma torch as a heater.

The melting part may include a first oxidant inlet.

The melting part may have a molten material outlet provided on a lower part of the melting part, from which a molten material is discharged.

The sedimentary part may have a pushing part to transport the deposited combustible material to the melting part.

The gasification part may have a second oxidant inlet.

The second oxidant inlet may be placed on a position enabling the oxidant to circulate in the gasification part.

The gasification part may further include a pilot burner to maintain a synthetic gas generated from the combustible material in ignition and combustion states.

The gasification part may have an outlet for discharging the synthetic gas provided at the top side thereof.

The plasma torch may include at least one non-transferred type plasma torch and at least one transferred type plasma torch.

The melting part may include an electrode for the transferred type plasma torch formed at a bottom side thereof.

The plasma torch may include a plurality of non-transferred type plasma torch and said at least one transferred type plasma torch, and the plasma torch is configured in such a way that the non-transferred type plasma torches are arranged on both sides of the transferred type plasma type torch.

The plasma torch may include a combined plasma torch which is operated alternately in both of a transferred mode and a non-transferred mode.

The plasma torch may conduct an alternate operation of the transferred type torch and the non-transferred type torch.

A gasification melting furnace may include: a sedimentary part in which a combustible material having multiple pores formed therein is deposited; a melting part having a heater to melt the combustible material introduced from the sedimentary part; and a gasification part into which a gas generated in the melting part is input after passing through the pores in the sedimentary part, wherein the gasification part does not directly communicate with the melting part.

The combustible material deposited in the sedimentary part may block an opening through which the melting part communicates with the sedimentary part to enable synthetic gas generated in the melting part to pass through the combustible material deposited in the sedimentary part.

A method for treating a combustible material in a gasification melting furnace having a melting part and a sedimentary part, includes: passing a gas generated in the melting part through the sedimentary part that includes the combustible material deposited therein and has multiple pores formed therein.

The gas may be generated by inputting the combustible material into the melting part and then heating the same.

The method may further include: oxidizing a part of the gas passing through the combustible material deposited in the sedimentary part.

The method may further include: inputting a first oxidant during generation of the gas in the melting part.

The gas may be generated by heating the combustible material using the plasma torch.

The heating may be performed by at least one non-transferred type plasma torch and at least one transferred type plasma torch.

The heating may be performed by alternating operation of a non-transferred type plasma torch and a transferred type plasma torch.

The method may further include: transporting the deposited combustible material deposited in the sedimentary part to the melting part.

The gas may have a temperature of 1,400° C. or higher.

The gas obtained after the oxidation may have a temperature of 1,200° C. or higher.

The oxidation may be performed by inputting a second oxidant.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating a gasification melting furnace according to a first embodiment of the present invention;

FIG. 2 is a cross-sectional view illustrating the gasification melting furnace shown in FIG. 1;

FIG. 3 is a cross-sectional view illustrating a gasification part of the furnace shown in FIG. 1;

FIG. 4 is a perspective view illustrating a gasification melting furnace according to a second embodiment of the present invention;

FIG. 5 is a cross-sectional view illustrating a gasification part of the furnace shown in FIG. 2;

FIG. 6 is a perspective view illustrating a gasification melting furnace according to a third embodiment of the present invention;

FIG. 7 is a cross-sectional view illustrating the gasification melting furnace shown in FIG. 6;

FIG. 8 is a view schematically illustrating a construction of a plasma torch module according to a fourth embodiment of the present invention;

FIG. 9 is a perspective view illustrating a plasma gasification melting furnace according to the fourth embodiment of the present invention;

FIG. 10 is a cross-sectional view illustrating the plasma gasification melting furnace shown in FIG. 9; and

FIG. 11 is a cross-sectional view illustrating a gasification part of the furnace shown in FIG. 9.

### DETAILED DESCRIPTION

Embodiments of the present invention discloses a gasification melting furnace which includes a sedimentary part including a combustible material deposited therein and multiple pores formed therein; a melting part to melt the combustible material introduced from the sedimentary part; and a gasification part into which a gas generated in the melting part is input after passing through the pores in the sedimentary part, thereby stably and rapidly treating the combustible material, reducing energy consumption of the heater, and providing a synthetic gas containing decreased hazardous substances. An embodiment of the present invention also discloses a method for treatment of the combustible material using the above furnace.

Hereinafter, exemplary embodiments of the present invention will be described with reference to the accompanying drawings. Prior to this, terms or words used in the specification and claims should not be construed as limited to a lexical meaning, and should be understood as appropriate notions by the inventor based on that he/she is able to define terms to describe his/her invention in the best way to be seen by others. Therefore, embodiments and drawings described herein are simply exemplary and not exhaustive, and it will be understood that various modifications and equivalents may be made to take the place of the embodiments.

### First Embodiment

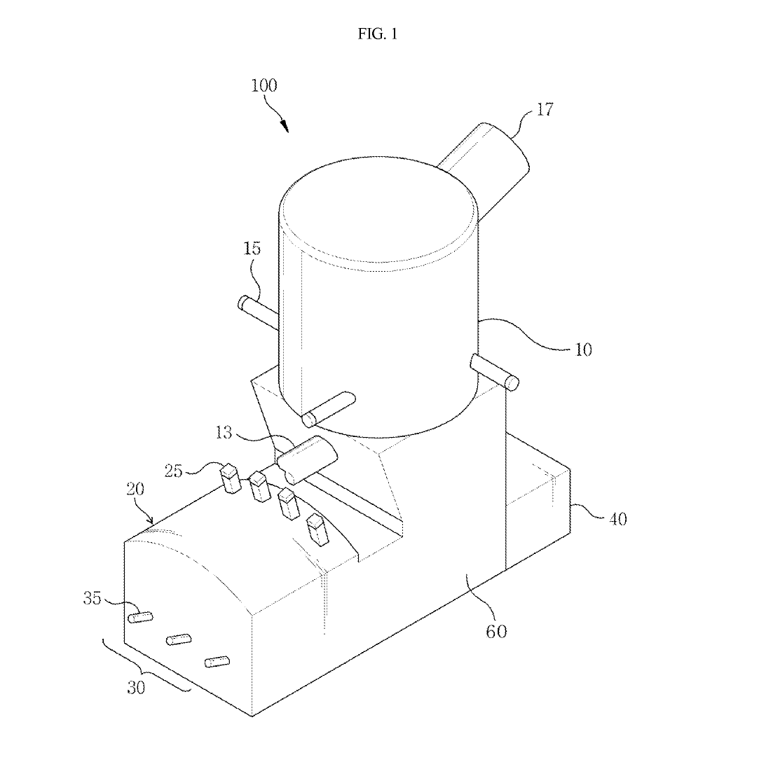

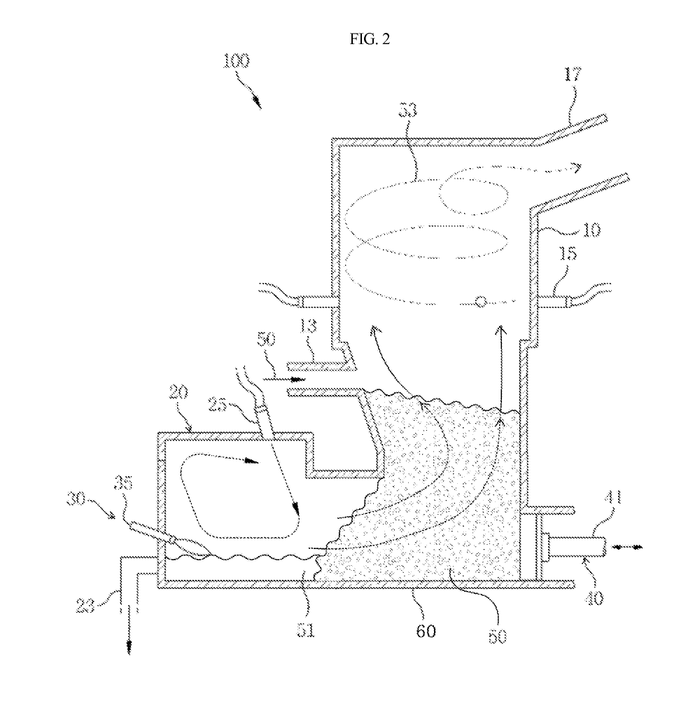

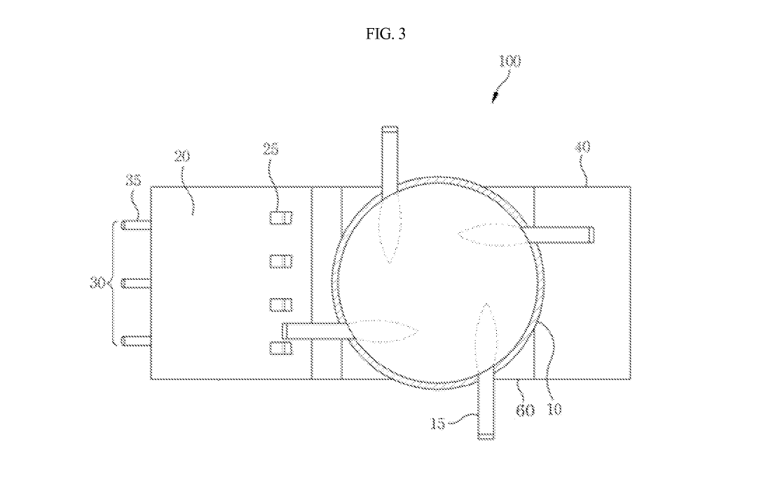

FIG. 1 is a perspective view illustrating a gasification melting furnace according to the first embodiment of the present invention, FIG. 2 is a cross-sectional view illustrating the gasification melting furnace shown in FIG. 1, and FIG. 3 is a cross-sectional view illustrating a gasification part of the furnace shown in FIG. 1.

Referring to FIGS. 1 to 3, the gasification melting furnace 100 according to the first embodiment of the present invention includes a gasification part 10, a melting part 20 and a sedimentary part 60. A combustible material 50 being input from the gasification part 10 is deposited in the sedimentary part 60, combustible components in the combustible material are converted into a synthetic gas 53 by a heater in the melting part 20, and the generated synthetic gas 53 is transferred through a sedimentary body formed of combustible materials 50 to the gasification part 10.

In this regard, gasification and partial oxidation carried out in the gasification melting furnace 100 according to the first embodiment are represented by Reaction Formulae 1 to 5 as follows. Herein, Reaction Formulae 1 and 2 express the gasification while Reaction Formulae 3 to 5 express the oxidation.

C(char)+H₂O→CO+H₂ [Reaction Formula 1]

C(char)+CO₂→2CO [Reaction Formula 2]

C+O₂→CO₂ [Reaction Formula 3]

CO+0.5O₂→CO₂ [Reaction Formula 4]

H₂+0.5O₂→H₂O [Reaction Formula 5]

As such, the gasification melting furnace 100 according to the first embodiment may be concretely described as follows.

The melting part 20 is provided to conduct melting and gasification of a combustible material 50 and heat exchange between the same and a synthetic gas, and includes a first oxidant inlet 25 and a heater 30.

The melting part 20 communicates with the sedimentary part 60 at one side while having a molten material outlet 23 provided at a lower part of the other side opposite to the one side, from which a molten material 51 is discharged. Accordingly, the melting part 20 may enable the molten material 51, which was formed by melting ash as an unburned component in the combustible material 50, to form a molten metal, and, when an amount of the molten material 51 reaches a predetermined level or more, discharge the molten metal to the outside through the molten material outlet 23. For instance, when the combustible material 50 containing ash is input into the melting part 20, the molten material 51 of the combustible material 50 may form a molten metal and a predetermined amount of the molten material 51 may remain in the melting part 20. That is, unburned fraction such as ash is normally molten at 1,200° C. or higher, and the molten material 51 is not directly discharged to the outside but used to form a predetermined amount of the molten metal in the melting part 20, thereby functioning as a heat sink against gasification and uniformly maintaining an internal temperature of the melting part 20 at a desired level. For example, the internal temperature of the melting part 20 can be controlled to allow the synthetic gas generated in a melting chamber to have a temperature of 1,400° C. or higher.

For example, the melting part 20 may be possibly configured in a rectangular shape such as a rectangular parallelepiped, i.e. a cuboid or a regular hexahedron, i.e. a cube.

The first oxidant inlet 25 is mounted at one lateral face or top side of the melting part 20, to input the oxidant through the same so as to maintain the melting part 20 under a reduction atmosphere. In such an aspect as described above, in order for the oxidant to easily circulate inside the melting part 20, the first oxidant inlet 25 may be inclined at a desired angle relative to the ground thereby an opening formed at a lower end of the first oxidant inlet 25 can be directed to face the sedimentary part 60.

The oxidant being input through the first oxidant inlet 25 may be pre-heated at 300 to 500° C. to prevent a decrease in temperature inside the melting chamber. The pre-heated oxidant is input through the first oxidant inlet 25. Herein, an input rate of the oxidant through the first oxidant inlet 25 may range 40 to 80 m/s. In this case, the oxidant may be air or oxygen.

The heater 30 may be mounted on a lateral wall of the melting part 20 and provide heat energy to melt and gasify the combustible material 50. In order to effectively transfer heat to the combustible material 50 or molten material 51, the heater 30 may be positioned to face the bottom face of the melting part 20. The heater 30 may be any heating means conventionally used in the art without particular limitation thereto. For instance, a plasma torch may be used.

When one example of the heater 30 used herein is the plasma torch, a plasma torch module 30 may include a plurality of plasma torches 35. In order to inhibit deterioration of the melting part 20 and damage to a refractory material by a plasma jet emitted by each plasma torch 35, a length of the plasma jet and an angle of mounting the plasma torch 35 need to be controlled to prevent the plasma jet from directly contacting the bottom face of the melting part 20. The plasma torch 35 may use compressed air, oxygen, steam, etc. as a plasma source.

The sedimentary part 60 is a part where the combustible material having multiple pores formed therein is deposited. The sedimentary part 60 is interposed between the melting part 20 and the gasification part 10 to prevent direct communication of the melting part 20 with the gasification part 10. Accordingly, positional interrelationship among the melting part 20, the sedimentary part 60, and the gasification part 10 is not particularly limited so far as the melting part 20 does not directly communicate with the gasification part 10.

According to the first embodiment of the present invention, the gasification part 10 is communicated to be positioned above the sedimentary part 60. However, a particular angle of connecting the sedimentary part 60 to the gasification part 10 is not particularly limited. Further, although the sedimentary part 60 is communicated to be positioned on one lateral face of the melting part 20, a particular angle of connecting a lateral face of the sedimentary part 60 to the melting part 20 is not particularly limited. In this regard, cross-sections of the melting part 20, the sedimentary part 60, and the gasification part 10 may be the same or different from one another.

According to the first embodiment of the present invention, because of a construction such that the sedimentary part 60 communicates with a lower part of the gasification part 10, the combustible material 50 being input through the gasification part 10 is deposited in the sedimentary part 60. Also, since the melting part 20 communicates with a lateral face of the sedimentary part 60, it is possible to control the molten material 51 to be present on the lower part of the melting part 20.

FIG. 2 schematically illustrates an exemplary shape of sedimentary body of the combustible material 50 formed in the sedimentary part 60. The sedimentary body of the combustible material 50 formed in the sedimentary part 60 blocks an opening through which the melting part 20 communicates with the sedimentary part 60, to thus enable the synthetic gas 53 generated in the melting part 20 to pass through the sedimentary body. In addition, the sedimentary body may prevent the synthetic gas 53 from directly entering the gasification part 10 without contacting the combustible material 50.

The sedimentary body may have a porous construction. Therefore, the synthetic gas 53 generated in the melting part 20 may preheat the combustible material 50 while passing through the sedimentary body with a porous construction and react with a part of the deposited combustible material 50 to induce gasification, to thus improve a treatment rate of the combustible material 50 and reduce energy consumption of the heater 30. In addition, since the melting part 20 wherein melting and gasification of the sedimentary body occur is separated from the gasification part 10 wherein the synthetic gas is partially oxidized, the gasification melting furnace 100 may be stably operated. In this case, the sedimentary part 60 exhibits gasification represented by Reaction Formulae 1 and 2.

A pushing part 40 may be further provided on an outer side of the sedimentary part 60 in an opposed direction of a direction at which the melting part 20 is connected, and have a pusher 41 to transport the combustible material 50 deposited in the sedimentary part 60 toward the melting part 20, thereby successfully melting and gasifying the combustible material 50. The pusher 41 used herein may include a cylinder type device, but not limited thereto. As such, the pushing part 40 transports the combustible material 50 toward the melting part 20, so as to stably supply the combustible material 50 to the melting part 20 and improve a treatment rate of the combustible material 50. Further, the treatment rate of the combustible material 50 may be easily controlled by controlling the operation state of the pushing part 40.

The gasification part 10 is a part wherein the combustible material 50 is input and partial oxidation occurs to maintain a temperature of the synthetic gas 53 at 1,200° C. or higher, communicates with the top side of the sedimentary part 60, and is provided with an inlet 13 for inputting the combustible material 50. The gasification part 10 is further provided with a plurality of second oxidant inlets 15 for inputting the oxidant at a lateral face, and has an outlet 17 for discharging the synthetic gas 53 on a top side of the gasification part. The oxidant used herein may be oxygen or air.

In this regard, the gasification part 10 may be mounted in a vertical direction, have a tubular structure, i.e., a barrel type structure extending in a vertical direction, and/or be formed to have an internal space decreasing down the sedimentary part 20. Although FIG. 1 is a perspective view illustrating an example of the gasification part 10 embodied in a cylindrical shape, a cross-section thereof is not particularly limited thereto.

Each second oxidant inlet 15 is a means for inputting the oxidant to induce oxidation in the gasification part 10. The second oxidant inlet 15 may be placed at a position higher than the inlet 13 for the combustible material 50, on an outer circumference of the gasification part 10.

If it is necessary, a plurality of the second oxidant inlet 15 may be provided and, in such a case, these inlets may be arranged at equal intervals and/or placed on the same plane. For instance, the first embodiment described, but is not limited to, an example provided with four second oxidant inlets 15. In other words, a plurality of first oxidant inlets 15 may be provided with the proper number thereof, depending upon a diameter of the gasification part 10.

The second oxidant inlet 15 may allow the oxidant to be input into the gasification part 10 in such a way that the oxidant avoids a central axis of the gasification part 10, thereby enabling the inputting oxidant to easily circulate in the gasification part 10. A reason of inputting the oxidant as described above is because partial oxidation of the oxidant with the synthetic gas transferred into the gasification part 10 can be stably conducted.

If it is necessary, the gasification part 10 may have a pilot burner near the second oxidant inlet 15 in order to maintain the synthetic gas 53 in ignition and combustion states.

In this case, the second oxidant inlet 15 may be positioned at a certain angle relative to the center, in order for the inputting gas to circulate inside the gasification part 10. As a result of the above, it is possible to extend a residual time of an unburned fraction in the gasification part 10 and reduce leakage of the unburned fraction out of the gasification part 10. For example, an overall input amount of the oxidant may be maintained in a range of 50 to 70% of a stoichiometric amount of the oxidant required for complete combustion while satisfying conditions for keeping a temperature of the gasification part 10 at 1,200° C. or higher.

Also, the first embodiment described, but is not limited to, an example in that an outlet 17 for discharging an exhaust gas including the synthetic gas 53 through the gasification part 10 is provided on a lateral face of the top side of the gasification part 10, in consideration of actually limited conditions such as an exit or height problem.

As such, the gasification melting furnace 100 according to the first embodiment may have the heater 30 to provide a heat source required for melting and gasification, and apply heat through partial oxidation by inputting an oxidant to a synthetic gas passing through the sedimentary part 60, thereby smoothly performing gasification at a high temperature of 1,200° C. or higher. In addition, since the gasification of the combustible material 50 is smoothly conducted, power consumption of plasma may be reduced.

### Second Embodiment

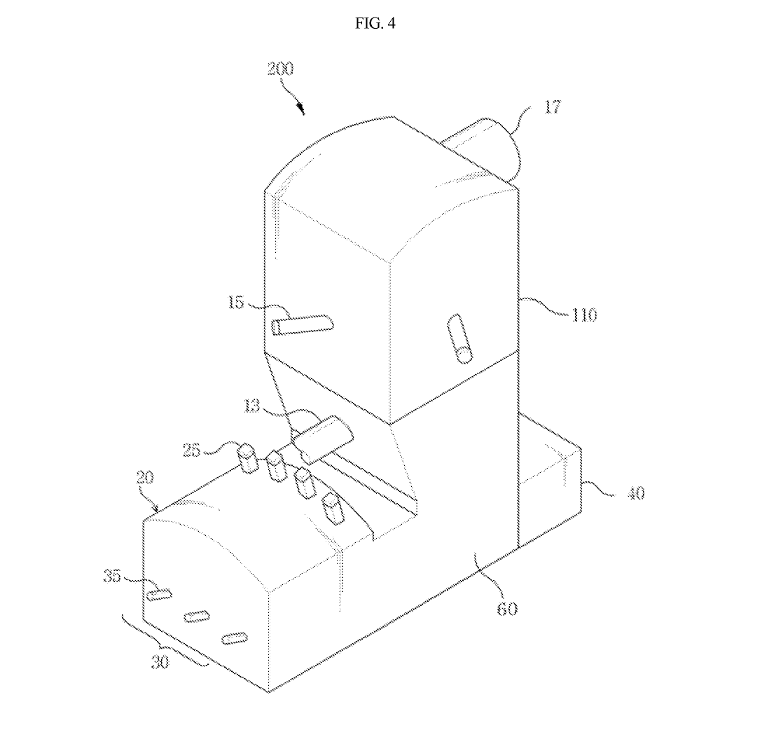

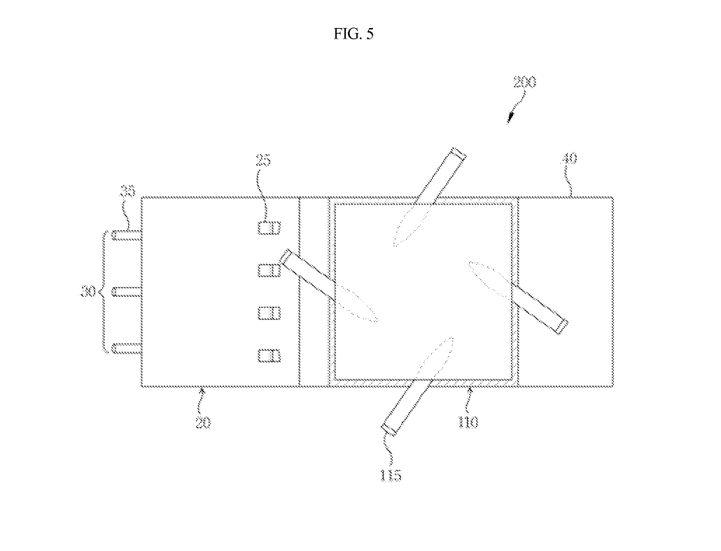

Although the first embodiment described an example of the gasification part 10 configured in a cylindrical shape, the configuration of the gasification part is not particularly limited to the above example. As shown in FIGS. 4 and 5, a gasification part 110 may be configured in a rectangular tube shape. Herein, FIG. 4 is a perspective view illustrating a gasification melting furnace 200 according to a second embodiment of the present invention. Also, FIG. 5 is a cross-sectional view illustrating the gasification part 110 shown in FIG. 4.

Referring to FIGS. 4 and 5, the gasification melting furnace 200 according to the second embodiment has substantially the same construction as the gasification melting furnace 100 according to the first embodiment, except that the gasification part 110 is configured in a rectangular tube shape. Therefore, the following description will be focused on the gasification part 110.

The gasification part 110 is connected to the top side of the sedimentary part 160, and has a plurality of second oxidant inlets 115 for inputting the oxidant mounted on a lateral face and an outlet 17 for discharging a synthetic gas mounted on a top side thereof Herein, the plurality of second oxidant inlets 115 are arranged at equal intervals on the lateral face of the gasification part 110, and may input the oxidant into the gasification part 110 in such a way that the oxidant avoids the center of the gasification part 110 and circulate the same therein. A reason of inputting the oxidant as described above is because partial oxidation of the oxidant with the synthetic gas transferred into the gasification part 110 can be stably conducted. In this case, the plurality of second oxidant inlets 115 may be placed on the same plane. For instance, the second embodiment described, but is not limited to, an example in that a plurality of second oxidant inlets 115 are provided on four lateral faces of the gasification part 110, respectively.

### Third Embodiment

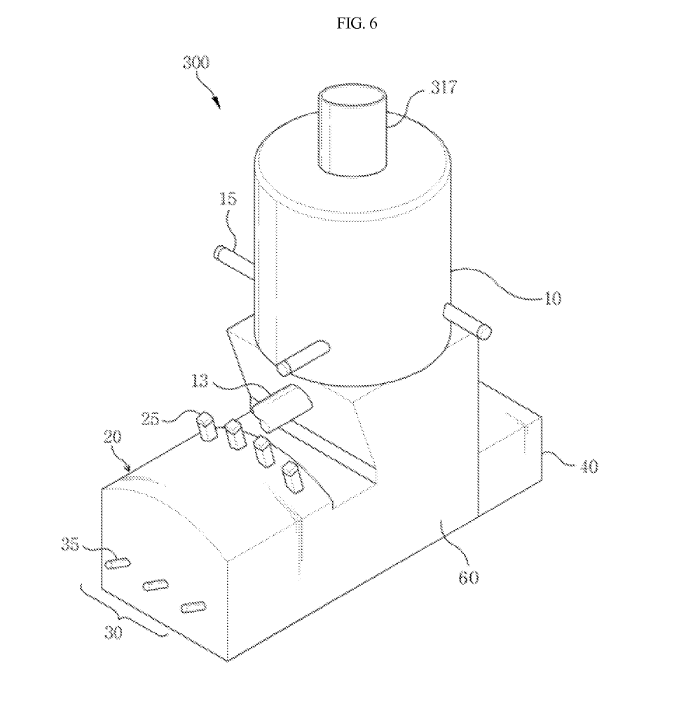

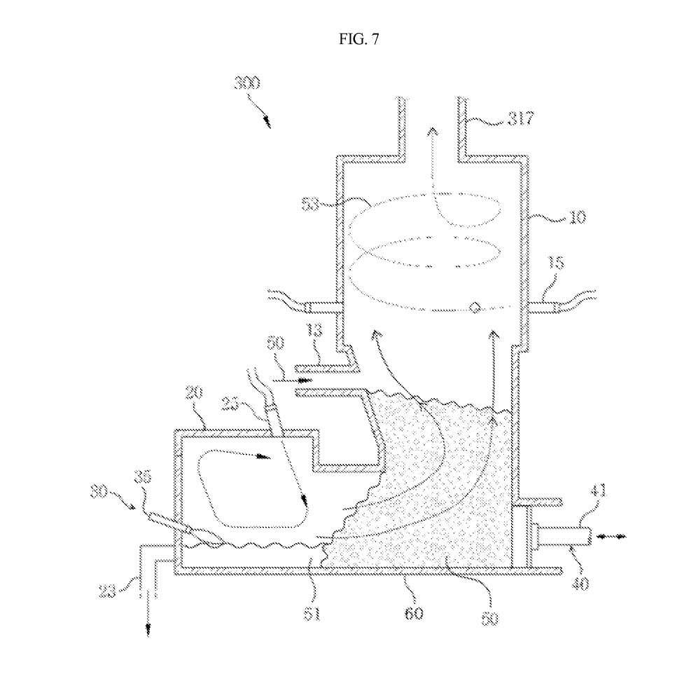

Although the first embodiment described an example in that an outlet 317 for discharging an exhaust gas including the synthetic gas 53 through the gasification part 10 is provided on a lateral face of the top side of the gasification part 10, in consideration of actually limited conditions such as an exit or height problem, a configuration of the outlet is not particularly limited to the above example. For instance, as shown in FIGS. 6 and 7, in order to inhibit escape of an unburned fraction or ash, the outlet 317 of the gasification part 10 may be provided to locate at the center of an upmost part of the gasification part 10. Herein, FIG. 6 is a perspective view illustrating a plasma gasification melting furnace 300 according to a third embodiment of the present invention. Also, FIG. 7 is a cross-sectional view illustrating the gasification melting furnace 300 shown in FIG. 6. The same parts as in the first embodiment will be denoted by the same reference numerals, description thereof will be omitted, and only differences will be described.

Referring to FIGS. 6 and 7, the plasma gasification melting furnace 300 according to the third embodiment has substantially the same melting part 20 and the gasification part 10 as described in the first embodiment, however, the outlet 317 is configured to have a different discharging position at which an exhaust gas is discharged through the center of a top dome part of the gasification part 10. When the exhaust gas is discharged out of the center of the outlet 317, a height of the gasification part 10 should be increased, however, carbide included in the combustible material passing through the sedimentary part 60 in the gasification part 10 may sufficiently undergo partial oxidation and a possibility of discharging the exhaust gas containing unburned carbon components may be further greatly reduced. Specifically, a circulating stream in the gasification part 10 formed by the second oxidant inlet 15 serves to further easily inhibit the discharge of carbide, thereby smoothly performing the partial oxidation while reducing an amount of carbide discharge in the exhaust gas.

### Fourth Embodiment

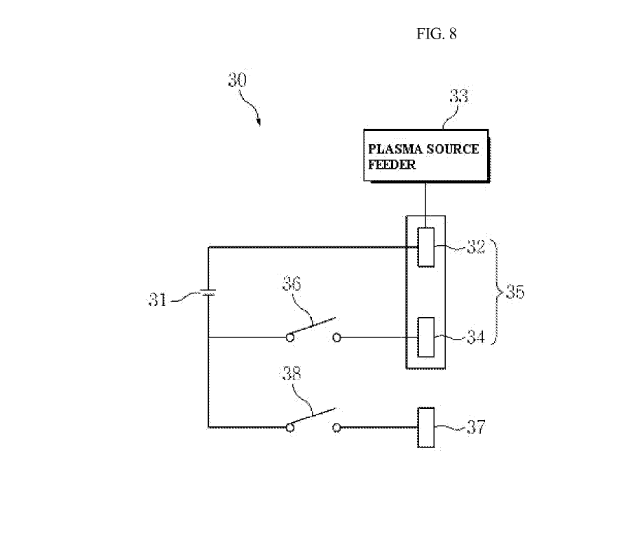

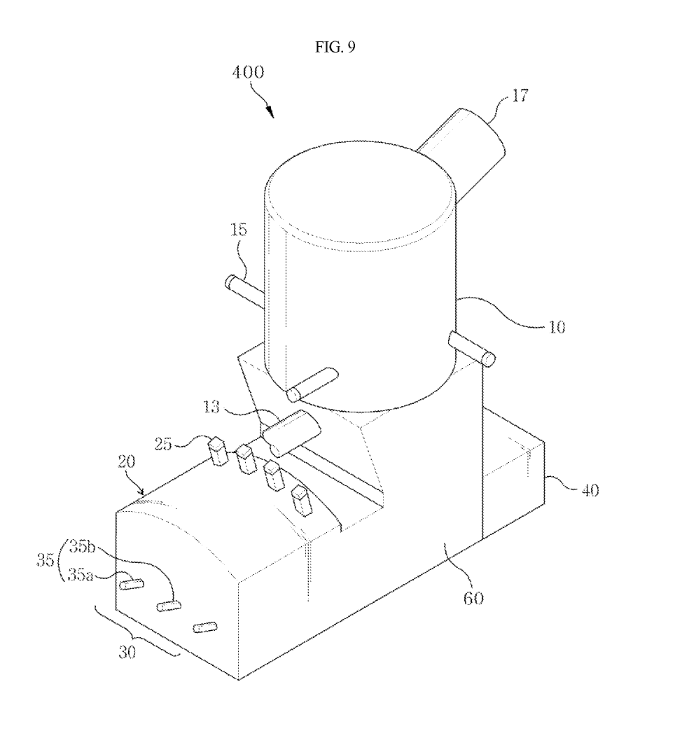

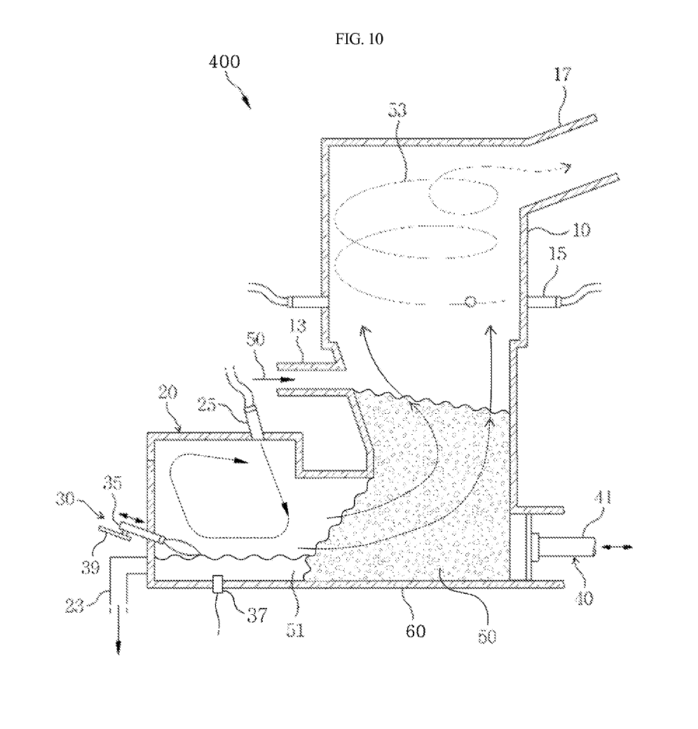

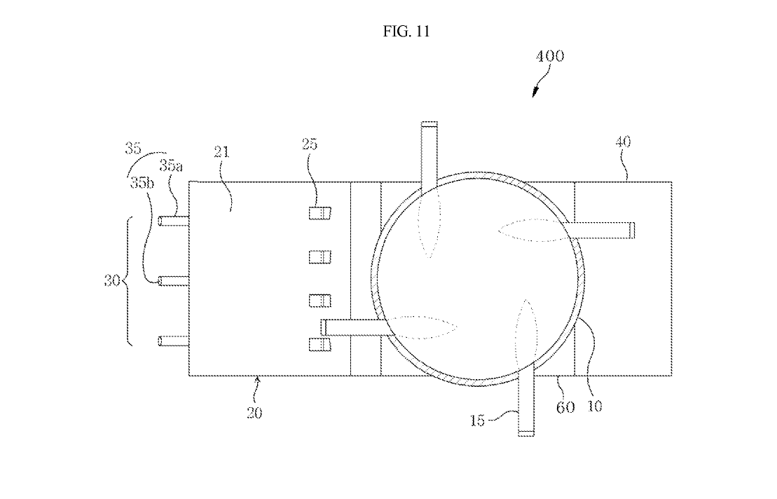

The plasma torch of an embodiment of the present invention, as shown in FIGS. 8 to 11, may simultaneously include transferred type and non-transferred type plasma torches.

As shown in FIGS. 8 to 11, the gasification melting furnace 400 according to the fourth embodiment has substantially the same construction as the melting furnace 100 (shown in FIG. 1) according to the first embodiment, except that the transferred type and non-transferred type plasma torches are concurrently provided. Therefore, the same parts as in the first embodiment will be denoted by the same reference numerals, description thereof will be omitted, and the following description will be focused on different features from the first embodiment.

A plasma torch module 30 may include a plurality of plasma torches 35 and these plasma torches 35 may be mounted on a lateral wall of the melting part 20 facing the gasification part 10. The plurality of plasma torches 35 may be configured to include at least one non-transferred type plasma torch 35a and at least one transferred type plasma torch 35b. Arrangement of the non-transferred type plasma torch 35a and transferred type plasma torch 35b is not particularly limited and, for example, the transferred type plasma torch 35b may be placed on the center while the non-transferred type plasma torches 35a may be provided on both sides of the transferred type plasma torch 35b.

Such a plasma torch module 30 may include a power supply 31, a plasma source feeder 33 and a plurality of plasma torches 35. For a transferred type, a torch-transferring unit 39 and a lower electrode 37 may be further provided. The power supply 31 provides energy required for generating a plasma arc. The plasma source feeder 33 provides the plasma source to each plasma torch 35. The plasma torch 35 conducts arc discharge of the plasma source provided by the plasma source feeder 33 as the power supply 31 is applied, thus generating the plasma arc. Additionally, the torch-transferring unit 39 may move the plasma torch 35 to a bottom side of the melting part 20 or far from the bottom side.

The plasma source feeder 33 may use compressed air, oxygen, or steam, etc., as a plasma source.

According to another aspect of the present invention, the plasma torch module 30 may include a combined plasma torch possibly operated in both of transferred and non-transferred modes. FIG. 8 is a view schematically illustrating one embodiment of such a combined plasma torch part 30.

For the combined plasma torch, the non-transferred mode means a mode to generate plasma by discharge between a rear electrode 32 and a front electrode 34, since a first switch 36 is closed. When the bottom of the melting furnace is heated and molten by the generated plasma, electric current can flow into the lower electrode 37. At this time, if the first switch 36 is open, the electric current flows from the rear electrode 32 to the lower electrode 37. This is referred to as a transferred mode.

If it is necessary, the non-transferred mode and transferred mode may be alternately operated. For example, after operating in the non-transferred mode, the operation may be changed into the transferred mode. At the beginning of operation, or in a case where a molten metal is not formed on a lower part of the melting part 20 due to other reasons or it is difficult to operate in the transferred mode, the non-transferred mode operation is used. Thereafter, when the molten metal is formed on the melting part 20 or the transferred mode operation is possible, the operation may be changed into the transferred mode. The reason of such a change of the operation mode is because the transferred mode operation can improve energy transfer efficiency of the torch since an arc point is formed on the bottom. In this case, a second switch 38 is always closed.

In order to understand features of the plasma gasification melting furnace 400 according to the fourth embodiment, a plasma gasification equipment provided with the plasma gasification melting furnace 400 according to the fourth embodiment was fabricated in a scale of processing capacity of 3 tons/day and wastes having constitutional compositions listed in Tables 1 and 2 below were subjected to a hydrogen recovery experiment.

TABLE 1

| Low potential calories | Three components (%) | | |
|---|---|---|---|
| (kcal/kg) | Combustible fraction | Ash | Water content |
| 3,330 | 68.8 | 10.6 | 20.6 |

TABLE 2
Constitutional components of combustible fraction (%)

| Nitrogen | Carbon | Hydrogen | Oxygen | Sulfur | Chlorine |
|---|---|---|---|---|---|
| 1.01 | 52.59 | 8.42 | 37.85 | 0.02 | 0.11 |

Each of the above wastes was fed into the plasma gasification equipment under conditions stated in Table 3 and the equipment was operated. The operation of the plasma gasification melting furnace 400 was conducted under conditions of constant pressure and temperature maintained in the furnace. In particular, the pressure is the most important parameter in ensuring stability of an overall process and should be maintained as constantly as possible. Such maintenance of pressure may be successfully attained by controlling a revolution number of a suction blower using an inverter. Meanwhile, a temperature of the plasma gasification melting furnace 400 is determined by an input amount of the waste. The input of waste was controlled by stopping the waste input when an internal temperature of the plasma gasification melting furnace 400 was high and inputting the waste when the temperature is decreased. When there was difficulty in maintaining the temperature of the input waste, the temperature was controlled by varying a power output of the plasma torch 35. Further, since the purpose of this process is to generate hydrogen, an oxidant having 93% oxygen concentration produced by oxygen PSA was introduced in order to increase a concentration of hydrogen in the oxidant. In this regard, Table 3 exhibits operational conditions of the plasma gasification melting furnace 400.

TABLE 3

| Items | Conditions | Note |
|---|---|---|
| Temperature of | 1,400 to 1,500° C. | Internal temperature of melting |
| melting furnace | | furnace |
| Oxygen input | 5 atm 12 Nm³/h | Feeding 93% oxygen by |
| | | oxygen PSA |
| Waste input rate | About 50 kg/h | |

In order to operate under the above conditions, as stated in Table 4, the plasma gasification melting furnace 400 in Example 1 was operated by providing two 50 kW grade plasma torches in a combined type (possibly operated in both of transferred mode and non-transferred mode) and a non-transferred type to the furnace. Further, two 50 kW grade plasma torches in a non-transferred type were provided and each was operated two times in Comparative Example 1. Herein, the plasma gasification melting furnaces according to Example 1 and Comparative Example 1 have substantially the same construction as the plasma gasification melting furnace 400 according to the fourth embodiment, except that the plural plasma torches in the furnaces have different configurations. Table 4 exhibits operational conditions of the plasma torch.

TABLE 4

| Items | Example 1 | Comparative Example 1 |
|---|---|---|
| Condition | One 50 kW combined type | Two 50 kW non-transferred |
| of torch | torch | type torches |
| | One 50 kW non-transferred | |
| | type torch | |
| Total power | 650 kW | 700 kW |
| consumption | | |
| Efficiency | Combined type (transferred | Non-transferred type 70% |
| of torch | mode operation) 80% | → Average 70% |
| | Non-transferred type 70% | |
| | → Average 75% | |
| Number of | Twice | Twice |
| times of | | |
| experiment | | |

During the experiment, a medium for the plasma torch was introduced using compressed air in an initial preheating process of the melting furnace, and then, oxygen was used instead of the air in a process for production of a synthetic gas by inputting the waste. Further, at each time during waste treatment four times, an average internal temperature of the melting furnace in an initial 5 hours was maintained at about 1,400° C.

As a result of the above experiment, it was observed that properties of the synthetic gas according to the treatment of waste are almost the same as levels shown in Table 5 below. In this regard, Table 5 exhibits CO and H₂ compositional distributions in the synthetic gas during experimental operation.

TABLE 5

| | | | Average of |
|---|---|---|---|
| | Average of CO | Average of H₂ | CO + H₂ |
| Experiment | concentration | concentration | concentration |
| Example 1 (first) | 38.770% | 35.205% | 73.975% |
| Example 1 (second) | 40.576% | 34.646% | 75.222% |
| Comparative | 37.646% | 33.926% | 71.572% |
| Example 1 (first) | | | |
| Comparative | 40.380% | 35.602% | 75.983% |
| Example 1 (second) | | | |

As such, referring to average values of CO+H₂ concentrations, it can be seen that there is no remarkable difference between Example 1 and Comparative Example 1 and both have an average of about 71 to 75%. However, the average value was varied over time and the reason of such variation is presumed to be due to differences in water content caused by differences in natural drying time of the waste to be treated as well as variation of properties of the same.

The exhaust gas emitted from the plasma gasification melting furnace is further purified using a wet type scrubber alone. As a result of entrapping the exhaust gas and measuring dioxin therein, a low content of about 0.02 ng TEQ/Nm³ can be monitored in both of Example 1 and Comparative Example 1. The measured value was obtained without introduction of special chemicals or alternative apparatuses for removing dioxin such as an adsorption column and the result demonstrates that the formation of dioxin in the plasma gasification melting furnace can be completely inhibited by a plasma gasification melting process.

Comparing Example 1 with Comparative Example 1, they show very little difference in actual results of synthetic gas production. However, as stated in Table 4, it can be seen that power input is different between the above examples. That is, Comparative Example 1 has a total power consumption of 700 kW while Example 1 exhibits a total power consumption of 650 kW, and thus, it can be seen that Example 1 has smaller power consumption than Comparative Example 1. Therefore, it is understood that the plasma gasification melting furnace 400 according to the fourth embodiment can be operated while reducing electrical energy to be used.

According to the gasification melting furnace of the present invention, since the gasification part does not directly communicate with the melting part, rapid transfer of the waste from the gasification part to the melting part may be prevented to thus stably process a combustible material, compared to a straight line structure.

Further, according to the gasification melting furnace of the present invention, since the synthetic gas generated in the melting part necessarily passes through the combustible material deposited in the sedimentary part, gasification of the combustible material may be sufficiently performed and a treatment rate of the combustible material may be improved.

Further, according to the gasification melting furnace of the present invention, since a region, wherein melting and gasification occur by the combustible material deposited in the sedimentary part, is isolated from a region for occurrence of partial oxidation, the gasification melting furnace may be stably driven. In other words, since the gasification melting furnace of the present invention may separate the melting part and the gasification part by the combustible material deposited in the sedimentary part, heat of the heater may be concentrated in the melting process, and hot gas generated during the above process passes through the combustible material in the sedimentary part, thus enabling efficient gasification of the combustible material. Moreover, by further partially oxidizing high calorie gas discharged from the sedimentary part to elevate a temperature to 1,200° C. or higher, a synthetic gas free from hazardous substances such as tar or dioxin can be produced.

Further, according to the gasification melting furnace of the present invention, in order to elevate a temperature that has been decreased when the synthetic gas generated in the melting part passes through the combustible material and moves toward the upper part of the gasification chamber, an oxidant may be added to the synthetic gas having passed through the combustible material to induce partial oxidation to thus gasify the combustible material, thereby generating the synthetic gas at a high temperature of 1,200° C. or higher while minimizing energy consumption of the heater.

As such, the gasification melting furnace of the present invention may stably maintain a gasification temperature at 1,200° C. or higher, so as to minimize formation of impurities and air contaminants in the synthetic gas. That is, when the gasification is conducted at a high temperature of 1,200° C. or higher, generation of hydrocarbons or ash may be minimized within properties of the discharged synthetic gas, and generation of oxide-based air contaminants such as nitrogen oxides (NOx), sulfur oxides (SOx), etc., may be successfully inhibited.

Further, with regard to the gasification melting furnace according to the embodiments of the present invention, a pushing part is provided in the sedimentary part to transport the combustible material toward the melting part to thus stably feed the combustible material to the melting part, thereby improving a treatment rate of the combustible material. Also, the pushing part may be driving-controlled to easily control the treatment rate of the combustible material.

Additionally, the gasification melting furnace according to the present invention may generate a synthetic gas at a high temperature of 1,200° C. or higher while stably treating a great amount of waste of 100 tons/day or more, thereby being applicable to development of gas engines and fuel cells.

Further, the gasification melting furnace according to another embodiment of the present invention may be provided with a combined plasma torch part of transferred type and non-transferred type torches. Since the transferred type torch does not work at the beginning of operation or in a case where a temperature of the melting part due to some reasons is low and molten metal is not formed, the molten metal is firstly formed by increasing the temperature of the molten metal and, when electric current can flow through a molten material due to the formed molten metal, melting may be continuously conducted with high efficiency by operating the transferred type torch. Consequently, the plasma torch part may have improved energy efficiency, thus reducing overall electrical energy to be used. Enthalpy applied through the transferred type torch may be utilized to accelerate the melting of non-combustible waste.

Meanwhile, although calories of the input waste is unexpectedly increased or decreased, gasification may proceed smoothly by controlling the electrical energy applied to the plasma torch.

Alternatively, in place of the transferred type torch, a combined torch possibly operated in both of transferred mode and non-transferred mode may be used. If the combined torch is used, the torch may be operated in the non-transferred mode at the beginning of operation or in a case where molten metal was not stably formed, then, when the molten metal has been adequately formed, the above non-transferred mode is changed into the transferred mode and the torch may be operated in the transferred mode.

While the present invention has been described with reference to the exemplary embodiments, it will be understood by those skilled in the related art that various modifications and variations may be made therein without departing from the scope of the present invention as defined by the appended claims.

What is claimed is:

1. A gasification melting furnace, comprising:
a sedimentary part in which a combustible material having multiple pores formed therein is deposited;
a melting part configured to melt the combustible material introduced from the sedimentary part; and
a gasification part into which a gas generated in the melting part is input after passing through the pores in the sedimentary part.

2. The furnace according to claim 1, further comprising a combustible material inlet through which the combustible material is input into the sedimentary part.

3. The furnace according to claim 1, wherein the melting part communicates with a lateral face of the sedimentary part and the gasification part communicates with a top side of the sedimentary part.

4. The furnace according to claim 1, wherein the melting part includes a plasma torch as a heater.

5. The furnace according to claim 1, wherein the melting part includes a first oxidant inlet.

6. The furnace according to claim 1, wherein the melting part has a molten material outlet provided on a lower part of the melting part, from which a molten material is discharged.

7. The furnace according to claim 1, wherein the sedimentary part has a pushing part to transport the deposited combustible material to the melting part.

8. The furnace according to claim 1, wherein the gasification part has a second oxidant inlet.

9. The furnace according to claim 8, wherein the second oxidant inlet is placed on a position enabling the oxidant to circulate in the gasification part.

10. The furnace according to claim 1, wherein the gasification part further comprises a pilot burner to maintain a synthetic gas generated from the combustible material in ignition and combustion states.

11. The furnace according to claim 1, wherein the gasification part has an outlet for discharging the synthetic gas provided at the top side thereof.

12. The furnace according to claim 4, wherein the plasma torch includes at least one non-transferred type plasma torch and at least one transferred type plasma torch.

13. The furnace according to claim 12, wherein the melting part includes an electrode for the transferred type plasma torch formed at a bottom side thereof.

14. The furnace according to claim 12, wherein the plasma torch includes a plurality of non-transferred type plasma torch and said at least one transferred type plasma torch, and the plasma torch is configured in such a way that the non-transferred type plasma torches are arranged on both sides of the transferred type plasma type torch.

15. The furnace according to claim 12, wherein the plasma torch includes a combined plasma torch which is operated alternately in both of a transferred mode and a non-transferred mode.

16. The furnace according to claim 12, wherein the plasma torch conducts an alternate operation of the transferred type torch and the non-transferred type torch.

17. A gasification melting furnace, comprising:
a sedimentary part in which a combustible material having multiple pores formed therein is deposited;
a melting part having a heater to melt the combustible material introduced from the sedimentary part; and
a gasification part into which a gas generated in the melting part is input after passing through the pores in the sedimentary part, wherein the gasification part does not directly communicate with the melting part.

18. The gasification melting furnace of claim 17, wherein the combustible material deposited in the sedimentary part blocks an opening through which the melting part communicates with the sedimentary part to enable synthetic gas generated in the melting part to pass through the combustible material deposited in the sedimentary part.

19. A method for treating a combustible material in a gasification melting furnace having a melting part and a sedimentary part, the method comprising:
passing a gas generated in the melting part through the sedimentary part that includes the combustible material deposited therein and has multiple pores formed therein.

20. The method according to claim 19, wherein the gas is generated by inputting the combustible material into the melting part and then heating the same.

21. The method according to claim 19, further comprising: oxidizing a part of the gas passing through the combustible material deposited in the sedimentary part.

22. The method according to claim 19, further comprising: inputting a first oxidant during generation of the gas in the melting part.

23. The method according to claim 19, wherein the gas is generated by heating the combustible material using a plasma torch.

24. The method according to claim 23, wherein the heating is performed by at least one non-transferred type plasma torch and at least one transferred type plasma torch.

25. The method according to claim 23, wherein the heating is performed by alternating operation of a non-transferred type plasma torch and a transferred type plasma torch.

26. The method according to claim 23, wherein the heating is performed by using a non-transferred type plasma torch and then a transferred type plasma torch.

27. The method according to claim 19, further comprising: transporting the combustible material deposited in the sedimentary part to the melting part.

28. The method according to claim 19, wherein the gas has a temperature of 1,400° C. or higher.

29. The method according to claim 21, wherein the gas obtained after the oxidation has a temperature of 1,200° C. or higher.

30. The method according to claim 21, wherein the oxidation is performed by inputting a second oxidant.
